(19) United States
(12) Patent Application Publication
(10) Pub. No.: US 2012/0074703 A1
(43) Pub. Date: Mar. 29, 2012

(54) CIRCULATING ELECTRIC GENERATOR

(76) Inventor: Chen-Chang Lin, Taichung City (TW)

(21) Appl. No.: 12/889,042

(22) Filed: Sep. 23, 2010

(51) Int. Cl. F03B 13/08

(52) U.S. Cl. 290/54

(57) ABSTRACT

A circulating electric generator of the present invention includes a case, a waterwheel mechanism, a drawing pipe, a generating mechanism and a pump. A partition is firmly disposed in the case. An upper space and a lower space are defined by the case and the partition. The partition is formed with a leaking aperture which communicates with the upper space and the lower space. The drawing pipe has a drawing end located at the bottom of the lower space and an expelling end located in the upper space. The pump is used to provide a pressure so as to draw liquid from the drawing end to the expelling end. As such, liquid can circulate between the upper space and the lower space. The waterwheel can be driven by the liquid, and can activate the generating mechanism so as to generating electric power.

### BACKGROUND OF THE INVENTION

1. Field of the Invention

The present invention relates to an electric generator which is activated by circulation of water.

2. Description of the Prior Art

Using and providing energy are important in modern society. We can say that human can not live without energies, such as electric power and fossil fuels.

Fossil fuels could not be used again ones it is exhausted. People concentrate on developing renewable energies, such as solar energy and waterpower, in recent years. However, there are still many technical bottlenecks on using these energies. For example, solar energy has to be used with a great deal of sunshine. Waterpower generator has to be constructed next to river. As a result, the renewable energies are instable and expensive, even unusable.

The present invention is, therefore, arisen to obviate or at least mitigate the above mentioned disadvantages.

### SUMMARY OF THE INVENTION

The main object of the present invention is to provide an electric generator which is easy to be settled and to be used.

To achieve the above and other objects, a circulating electric generator of the present invention includes a case, a waterwheel mechanism, a drawing pipe, a generating mechanism and a pump.

A partition is firmly disposed in the case. An upper space and a lower space are defined by the case and the partition. The partition is positioned between the upper space and the lower space. The partition is formed with a leaking aperture. The leaking aperture communicates with the upper space and the lower space.

The waterwheel mechanism is located in the lower space.

The drawing pipe has a drawing end and an expelling end. The drawing end is located at a bottom of the lower space. The expelling end is located in the upper space.

The pump is used to provide a pressure so as to draw liquid from the drawing end to the expelling end.

The generating mechanism is driven by the waterwheel mechanism so as to generate electric power.

Liquid is contained in both of the upper space and the lower space. The liquid in the upper space is affected by gravity. The liquid in the upper space is gathered at a bottom of the upper space. The liquid in the upper space leaks into the lower space via the leaking aperture and is gathered at the bottom of the lower space.

The liquid leaks into the lower space from the upper space, so that air pressure of the lower space is arisen. The liquid in the lower space is drawn into the upper space via the drawing pipe by air pressure and the pump, so that the liquid circulates between the upper space and the lower space.

The liquid makes the waterwheel mechanism rotate before moving to the bottom of the lower space. The waterwheel mechanism drives the generating mechanism to rotate.

In some cases, the waterwheel mechanism and the generating mechanism may be located in the upper space.

In some cases, the circulating electric generator may include two waterwheel mechanisms and two generating mechanisms. One waterwheel mechanism and one generating mechanism are located in the upper space. The other one of the waterwheel mechanisms and the other one of the generating mechanisms are located in the lower space.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a prefered embodiment of the present invention;

FIG. 2 is a side cross-sectional drawing showing a prefered embodiment of the present invention;

FIG. 3 is a side cross-sectional drawing showing a prefered embodiment of the present invention.

### DETAILED DESCRIPTION OF THE PREFERRED EMBODIMENTS

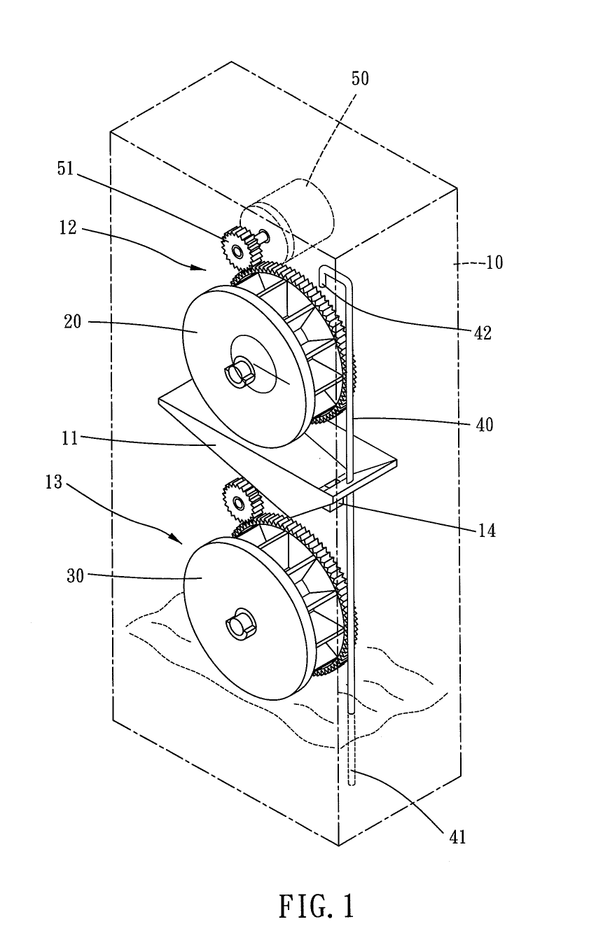

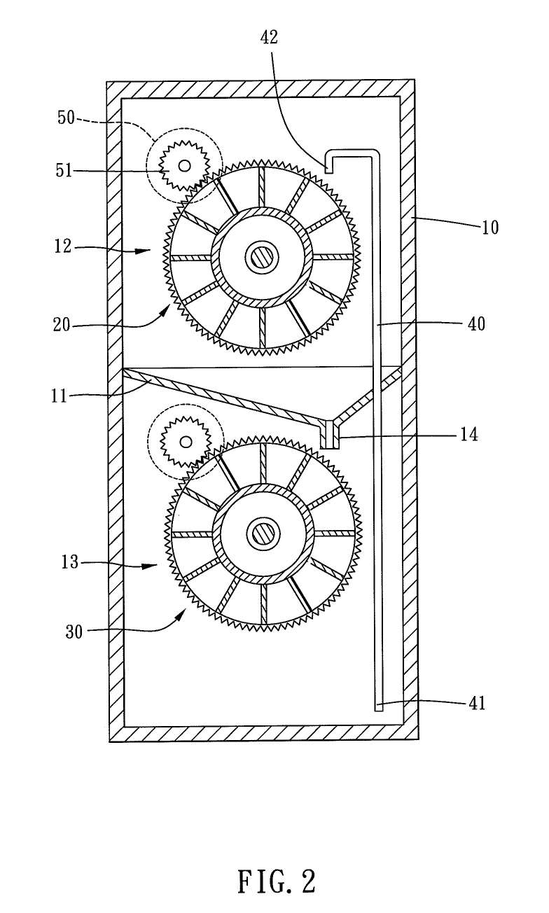

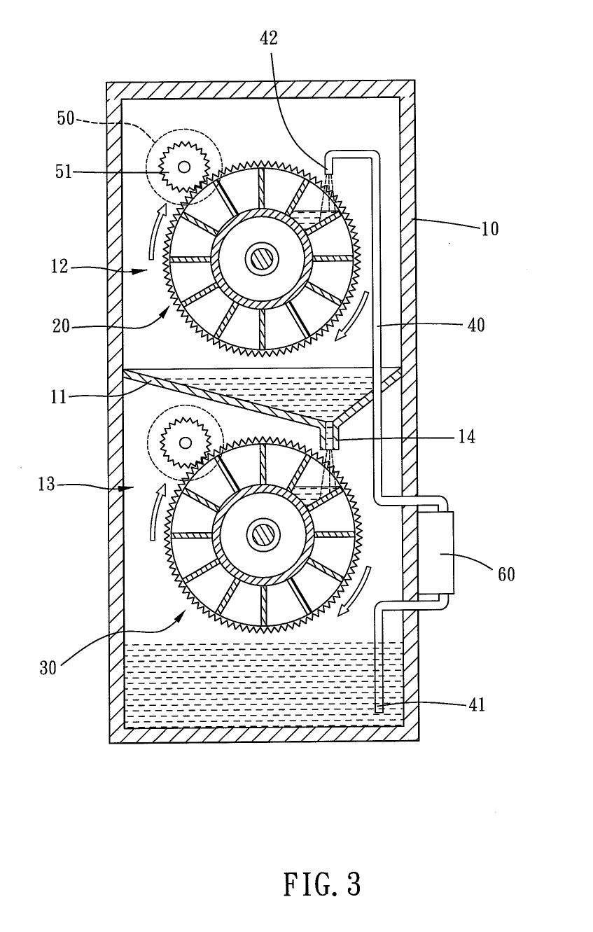

Please refer to FIG. 1 to FIG. 3 for a prefered embodiment of the present invention. The circulating electric generator of the present embodiment includes a case 10, an upper waterwheel mechanism 20, a lower waterwheel mechanism 30, a drawing pipe 40, a first generating mechanism, a second generating mechanism 50 and a pump 60.

A partition 11 is firmly disposed in the case 10. An upper space 12 and a lower space 13 are defined by the case 10 and the partition 11. In other possible embodiments of the present invention, more space may be defined by the case and the partition. Preferably, the upper space 12 and the lower space 13 are both closed space. The partition 11 is positioned between the upper space 12 and the lower space 13. The partition 11 is formed with a leaking aperture 14. The leaking aperture 14 communicates with the upper space 12 and the lower space 13. The partition 11 may be a single plate. Preferably, the partition 11 is funnel-shaped. The leaking aperture 14 is located on a bottom of the partition 11. The bottom of the partition 11 may be formed in tubular-shaped.

The upper waterwheel mechanism 20 is located in the upper space 12. The lower waterwheel mechanism 30 is located in the lower space 13. The position of the lower waterwheel mechanism 30 corresponds to the position of the leaking aperture 14. The periphery of the upper waterwheel mechanism 20 and the lower waterwheel mechanism 30 are formed with plurality of concavities. The concavities are adapted for water to fill therein.

The drawing pipe 40 has a drawing end 41 and an expelling end 42. The drawing end 41 is located at a bottom of the lower space 13. The expelling end 42 is located in the upper space 12. The position of the expelling end 42 corresponds to the upper waterwheel mechanism 20. The cross-section area of the opens of the drawing end 41 and the expelling end 42 may greater than the cross-section area of the leaking aperture 14.

The first generating mechanism and the second generating mechanism 50 are individually driven by the upper waterwheel mechanism 20 and the lower waterwheel mechanism 30. Preferably, one transmission mechanism, such as the gear set shown in drawings, is engaged between a waterwheel mechanism and a generating mechanism. The upper waterwheel mechanism 20 and the lower waterwheel mechanism 30 are formed with plurality of protruding portions. The protruding portions are located on the annular peripheries of the upper waterwheel mechanism 20 and the lower waterwheel mechanism 30. The protruding portions are engaged with the gear 51 of the gear set, so that the upper waterwheel mechanism 20 and the second generating mechanisms 50 are in a rotational operative relationship. Also, the lower waterwheel mechanism 30 and the first generating mechanism are in a rotational operative relationship. In other possible embodiments of the present invention, the generating mechanisms may be indirectly connected to the waterwheel mechanisms by belts or linkages, or be directly connected to the waterwheel mechanisms. In some cases, the generating mechanisms may be disposed on the center of the upper waterwheel mechanism and the lower waterwheel mechanism.

The pump 60 is used to provide a pressure so as to draw liquid from the drawing end 41 to the expelling end 42. Preferably, the pump 60 has a pressure detector which is used to detect the pressure of the upper space 12 and the pressure of the lower space 13.

Liquid, such as water or oil, is contained in both of the upper space 12 and the lower space 13. The liquid in the upper space 12 is affected by gravity. Therefore, the liquid in the upper space 12 is gathered at the bottom of the upper space 12, and leaks into the lower space 13 via the leaking aperture 14. The liquid fall into the concavity of the lower waterwheel mechanism 30. After liquid accumulates in the concavity, the liquid rotates the lower waterwheel mechanism 30, and is gathered at the bottom of the lower space 13.

The liquid leaks into the lower space 13 from the upper space 12, so that air pressure of the lower space 13 is arisen, and the air pressure of the upper space 12 is decreased. The liquid in the lower space 13 is drawn into the upper space 12 via the drawing pipe 40 by the pump 60 and the air pressure difference between the upper space 12 and the lower space 13. When the liquid is drawn back into the upper space 12, the liquid falls into the concavity of the upper waterwheel mechanism 20. As such, the upper waterwheel mechanism 20 is rotated by the liquid. The liquid is gathered at the bottom of the upper space 12 again. The liquid circulates between the upper space 12 and the lower space 13.

Accordingly, the circulating electric generator can be disposed in buildings. The water flow is quite stable. As such, the power generating rate of the circulating electric generator is stable. The circulating electric is durable, and can be built in different surroundings.

What is claimed is:

1. A circulating electric generator, comprising:
a case, a partition being firmly disposed in the case, an upper space and a lower space being defined by the case and the partition, the partition being positioned between the upper space and the lower space, the partition being formed with a leaking aperture, the leaking aperture communicating with the upper space and the lower space;
at least one lower waterwheel mechanism, located in the lower space;
a drawing pipe, having a drawing end and an expelling end, the drawing end being located at a bottom of the lower space, the expelling end being located in the upper space;
a pump, being used to provide a pressure so as to draw liquid from the drawing end to the expelling end; and
a first generating mechanism, being driven by the lower waterwheel mechanism so as to generate electric power;
wherein liquid is contained in both of the upper space and the lower space, the liquid in the upper space is affected by gravity, the liquid in the upper space is gathered at a bottom of the upper space, the liquid in the upper space leaks into the lower space via the leaking aperture and is gathered at the bottom of the lower space;
wherein the liquid leaks into the lower space from the upper space, so that air pressure of the lower space is arisen, the liquid in the lower space is drawn into the upper space via the drawing pipe by air pressure and the pump, so that the liquid circulates between the upper space and the lower space;
wherein the liquid makes the lower waterwheel mechanism rotate before moving to the bottom of the lower space, the lower waterwheel mechanism drives the first generating mechanism.

2. The circulating electric generator of claim 1, wherein the circulating electric generator further comprises a transmission mechanism, the transmission mechanism is a gear set, the transmission mechanism is engaged between the lower waterwheel mechanism and the first generating mechanism.

3. The circulating electric generator of claim 2, wherein the lower waterwheel mechanism is formed with plurality of protruding portions, the protruding portions are located on an annular periphery of the lower waterwheel mechanism, the protruding portions are engaged with a gear of the gear set, so that the lower waterwheel mechanism and the gear are in a rotational operative relationship.

4. The circulating electric generator of claim 1, wherein the partition is funnel-shaped, the leaking aperture is located on a bottom of the partition.

5. The circulating electric generator of claim 3, wherein the circulating electric generator further comprises an upper waterwheel mechanism and a second generating mechanism, the upper waterwheel mechanism is located in the upper space, the second generating mechanism is driven by the upper waterwheel mechanism so as to generate electric power.

6. A circulating electric generator, comprising:
a case, a partition being firmly disposed in the case, an upper space and a lower space being defined by the case and the partition, the partition being positioned between the upper space and the lower space, the partition being formed with a leaking aperture, the leaking aperture communicating with the upper space and the lower space;
at least one upper waterwheel mechanism, located in the upper space;
a drawing pipe, having a drawing end and an expelling end, the drawing end being located at a bottom of the lower space, the expelling end being located in the upper space;
a pump, being used to provide a pressure so as to draw liquid from the drawing end to the expelling end; and
a second generating mechanism, being driven by the upper waterwheel mechanism so as to generate electric power;
wherein liquid is contained in both of the upper space and the lower space, the liquid in the upper space is affected by gravity, the liquid in the upper space is gathered at a bottom of the upper space, the liquid in the upper space leaks into the lower space via the leaking aperture and is gathered at the bottom of the lower space;
wherein the liquid leaks into the lower space from the upper space, so that air pressure of the lower space is arisen, the liquid in the lower space is drawn into the upper space via the drawing pipe by air pressure and the pump, so that the liquid circulates between the upper space and the lower space;
wherein the liquid makes the upper waterwheel mechanism rotate after the liquid is drawn to the upper space via the drawing pipe, the upper waterwheel mechanism drives the second generating mechanism.

7. The circulating electric generator of claim 6, wherein the circulating electric generator further comprises a transmission mechanism, the transmission mechanism is engaged between the upper waterwheel mechanism and the second generating mechanism.

8. The circulating electric generator of claim 7, wherein the transmission mechanism is a gear set.

9. The circulating electric generator of claim 8, wherein the upper waterwheel mechanism is formed with plurality of protruding portions, the protruding portions are located on an annular periphery of the upper waterwheel mechanism, the protruding portions are engaged with a gear of the gear set, so that the upper waterwheel mechanism and the gear are in a rotational operative relationship.

10. The circulating electric generator of claim 6, wherein the partition is funnel-shaped, the leaking aperture is located on a bottom of the partition.
